(19) United States
(12) Patent Application Publication
(10) Pub. No.: US 2007/0046205 A1
(43) Pub. Date: Mar. 1, 2007

(54) Plasma display panel and method of manufacturing the same

(76) Inventors: Jae-Ik Kwon, Suwon-si (KR); Won-Ju Yi, Suwon-si (KR); Ho-Young Ahn, Suwon-si (KR); Kyoung-Doo Kang, Suwon-si (KR); Soo-Ho Park, Suwon-si (KR); Seok-Gyun Woo, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/507,871

(22) Filed: Aug. 21, 2006

(30) Foreign Application Priority Data
Aug. 27, 2005 (KR) 10-2005-0079122

(51) Int. Cl. H01J 17/49

(52) U.S. Cl. 313/582

(57) ABSTRACT

Provided is a plasma display panel and a method of manufacturing the same. The method of manufacturing the plasma display panel includes preparing a front substrate and a rear substrate and arranging the front and rear substrates to face each other; forming an exhaust hole in a discharge sheet; disposing the discharge sheet between the front and rear substrates; sealing a space between the front and rear substrates by coating a sealing member along edge surfaces of the front and rear substrates; and vacuuming the space between the front and rear substrates through an exhaust pipe formed on an outer surface of one of the front and rear substrates and connected to the exhaust pipe. The exhaust hole formed between the substrates has greater diameter than the discharge cells defined by the dielectric walls. Therefore, an inner region of the front substrate and an inner region of the rear substrate are subjected to substantially the same force.

### CROSS-REFERENCE TO RELATED APPLICATIONS

This application claims the benefit of Korean Patent Application No. 10-2005-0079122, filed on Aug. 27, 2005, in the Korean Intellectual Property Office, the disclosure of which is incorporated herein in its entirety by reference.

### BACKGROUND OF THE INVENTION

1. Field of the Invention

The present embodiments relate to a plasma display panel, and more particularly, to a plasma display panel having an improved exhaust hole structure so that air can be smoothly exhausted when the plasma display panel is vacuumed, and a method of manufacturing the same.

2. Description of the Related Art

Generally, plasma display panels (PDPs) can be classified into direct current (DC) PDPs and alternating current (AC) PDPs according to the type of driving voltage applied to discharge cells, i.e., according to discharge type. PDPs can further be classified into facing discharge PDPs and surface discharge PDPs according to the arrangement of electrodes.

A conventional three-electrode surface discharge type PDP includes a first substrate and a second substrate. An X electrode and a Y electrode are formed on an upper surface of the first substrate, a first dielectric layer buries the X electrode and the Y electrode, and a protective film layer is formed on a surface of the dielectric layer. An address electrode is disposed on an upper surface of the second substrate, and the address electrode is buried by a second dielectric layer. A barrier rib structure is disposed between the front substrate and the rear substrate, and red, green, or blue phosphor layers are formed on sidewalls of the barrier rib structure. The X and Y electrodes each include a transparent electrode line and a bus electrode electrically connected to the transparent electrode line.

To drive a PDP, a discharge cell in which a discharge is generated to emit light is selected by applying an electrical signal to the address electrode and the Y electrode. Then, an electrical signal is alternately applied to the X electrode and the Y electrode to emit visible light from the phosphor layer in the selected discharge cell. Thus, a stationary image or a moving image can be generated.

A method of manufacturing a conventional three-electrode surface discharge type plasma display panel will now be described.

In the first substrate, a plurality of X electrodes and Y electrodes are formed on a first substrate. A first dielectric layer that buries the X and Y electrodes is printed thereon. A protective film layer such as an MgO layer is deposited on a surface of the first dielectric layer.

In the second substrate, a plurality of address electrodes crossing the X and Y electrodes are formed. A second dielectric layer that buries the address electrodes is printed thereon. A barrier rib structure is disposed on an upper surface of the second dielectric layer, and red, green, and blue phosphor layers are coated on sidewalls of the barrier rib structure.

After the first and second substrates are aligned to face each other, a sealing member such as frit glass is coated along edge surfaces of the first and second substrates, and the first and second substrates are sealed by annealing at an appropriate temperature. Then, to remove moisture or impurities remaining in the space between the sealed first and second substrates, a gas exhaust process is performed in a vacuum state using an exhaust apparatus.

Next, a discharge gas containing Xe as a main component is filled in the space between the first and second substrates, and the plasma display panel is separated from the exhaust apparatus. Finally, an aging discharge is generated by applying a predetermined voltage to the plasma display panel, and driving integrated circuits (Ics) are mounted to complete the manufacturing of the plasma display panel.

To exhaust gas from the plasma display panel, an exhaust hole is formed through an edge of one of the first and second substrates. An exhaust pipe connected to the exhaust hole is formed on a rear surface of one of the first and second substrates.

The conventional three-electrode surface discharge type plasma display panel has the following drawbacks.

First, the transmittance of light emitted from a conventional discharge cell is less than 60% due to not only the X and Y electrodes, but also a front dielectric layer and a protective film layer sequentially formed on an inner surface of the first substrate. Therefore, a high efficiency flat panel display device cannot be realized.

Second, when a conventional panel is operated for a prolonged period of time, a permanent latent image occurs due to ion sputtering of charged particles of a discharge gas onto a phosphor layer due to an electric field produced when the discharge diffuses toward the phosphor layer.

Third, a discharge diffuses from a discharge gap between the X and Y electrode toward the outside. At this time, the discharge diffuses along the plane of the first substrate, and thus the space efficiency of the discharge cells is low.

Fourth, when a discharge gas containing a high concentration Xe gas, for example, 10 vol % or more, is filled in discharge cells, more plasma is produced. The plasma increases ionization of atoms and excitation reaction, thus, more charged particles and excitation species are produced. Accordingly, brightness and discharge efficiency of a device can be high. However, the high concentration of the Xe gas results in a high initial discharge firing voltage. The present invention overcomes these and other disadvantages of conventional plasma display panels.

### SUMMARY OF THE INVENTION

The present embodiments provide a plasma display panel having an improved exhaust structure to increase the gas exhaust capability of the plasma display panel, and a method of manufacturing the same.

In one aspect of the present embodiments, the space efficiency of the discharge cells of a PDP can be increased by disposing a plurality of electrodes around the discharge cells. In some embodiments, an improved exhaust structure for gas exhaustion is also included.

According to an aspect of the present embodiments, there is provided a plasma display panel comprising: a front substrate; a rear substrate facing the front substrate; and a discharge sheet which is disposed between the front and rear substrates and has an exhaust hole that provides a gas exhaust path for discharging an exhaust gas including impurity gases from a sealed discharge space during a vacuuming process.

The discharge sheet may comprise: a plurality of dielectric walls that define a plurality of discharge cells together with the front and rear substrates; a plurality of discharge electrodes that are disposed in the dielectric wall and surround the discharge cells; a plurality of phosphor layers formed in the discharge cells; and a discharge gas filled in the discharge cells.

The exhaust hole may be connected to an exhaust pipe installed on an outer surface of one of the front and rear substrates via a connection hole perforated through the one of the front and rear substrates.

A discharge space formed by coupling the front and rear substrates may define a display area where an image is displayed and a non-display area along the edges of the display area, and the exhaust hole is formed in the non-display area.

The exhaust hole may have a greater diameter than each of the discharge cells defined by the dielectric wall.

The exhaust hole may have a greater diameter than the exhaust pipe.

According to an aspect of the present embodiments, there is provided a method of manufacturing a plasma display panel, comprising: preparing a front substrate and a rear substrate and arranging the front and rear substrates to face each other; forming an exhaust hole in a discharge sheet; disposing the discharge sheet between the front and rear substrates; sealing a space between the front and rear substrates by coating a sealing member along edge surfaces of the front and rear substrates; and vacuuming the space between the front and rear substrates through an exhaust pipe formed on an outer surface of one of the front and rear substrates and connected to the exhaust pipe.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a plasma display device assembly according to an embodiment;

FIG. 2 is an exploded partial perspective view of a plasma display panel according to an embodiment;

FIG. 3 is perspective view of a discharge electrode of FIG. 2;

FIG. 4 is an exploded perspective view of the entire plasma display panel of FIG. 2; and

FIG. 5 is a cross-sectional view taken along line I-I of FIG. 4.

### DETAILED DESCRIPTION OF THE INVENTION

The present embodiments will now be described more fully with reference to the accompanying drawings in which exemplary embodiments are shown.

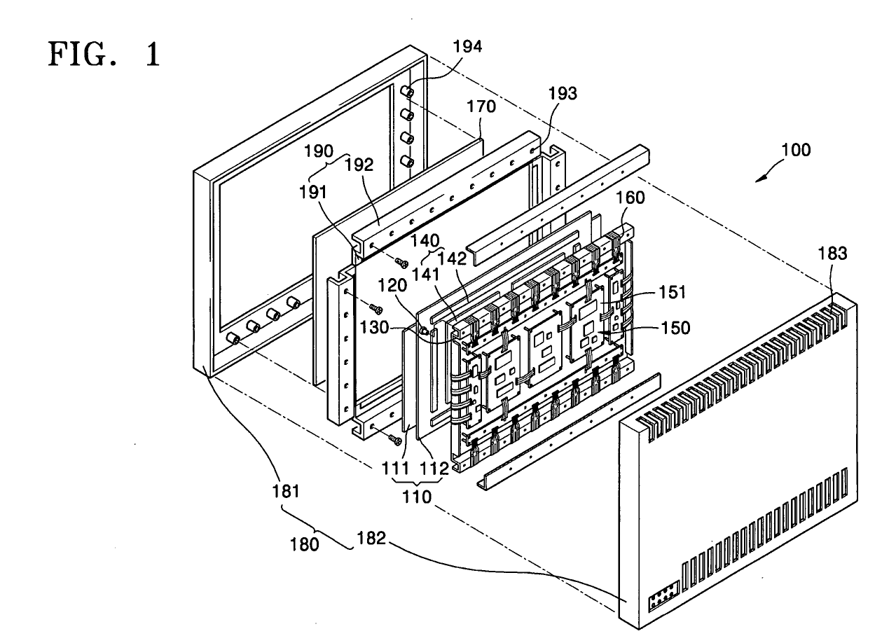

FIG. 1 is an exploded perspective view of a plasma display device assembly 100 according to an embodiment.

Referring to FIG. 1, the plasma display device assembly 100 includes a panel assembly 110 having a front panel 111, which is a first panel, and a rear panel 112, which is a second panel, facing the front panel 111. An inner space between the front panel 111 and the rear panel 112 is sealed from the outside by coating a sealing member such as frit glass, which will be described later, along inner edges of the front panel 111 and the rear panel 112 facing each other.

Also, an exhaust pipe 120 for discharging an exhaust gas containing impurity gases from a discharge space of the panel assembly 110 during a vacuuming process is installed on an outer edge of the rear panel 112.

A chassis base 130 is disposed on the rear of the panel assembly 110, and is coupled to the panel assembly 110 by an adhesive element 140. The adhesive element 140 includes a heat dissipation sheet 141 attached to a central portion of the rear panel 112 and a double-sided tape 142 attached to edges of the rear panel 112. The heat dissipation sheet 141 can dissipate heat generated by the panel assembly 110.

Driving circuit units 150 are mounted on a rear surface of the chassis base 130. Each of the driving circuit units 150 includes a plurality of circuit devices 151, and is connected to flexible printed cables 160.

The flexible printed cables 160 electrically connect terminals of each electrode of the panel assembly 110 to terminals of the driving circuit unit 150 to transmit electrical signals therebetween.

A filter assembly 170 is installed in front of the panel assembly 110 to operation, or to prevent the reflection of an external light.

To this end, the filter assembly 170 includes a reflection prevention film that is attached to the transparent substrate and prevents a reduction in visibility due to the reflection of light, an electromagnetic wave shielding layer for effectively shielding electromagnetic waves generated by the panel assembly 10 during operation, and a selective wave absorption film for shielding near infrared rays and neon light. Alternatively, the filter assembly 170 can include a plurality of films without the transparent substrate, and can be directly attached to a front surface of the front panel 111.

The panel assembly 110, the chassis base 130, and the filter assembly 170 are accommodated in a case 180. The case 180 includes a front cabinet 181 disposed in front of the filter assembly 170 and a back cover 182 disposed behind the chassis base 130. A plurality of vent holes 183 are formed in upper and lower parts of the back cover 182.

A filter holder 190 is mounted on a backside of the filter assembly 170. The filter holder 190 includes a pressing portion 191 that presses the filter assembly 170 toward the front cabinet 181 and a fixing portion 192 in a C-shape protruding toward the back of the assembly and connected to the pressing portion 191. The fixing portion 192 includes a plurality of coupling holes 193.

Filter mounting units 194 are installed on a rear surface of the front cabinet 181. The filter mounting units 194 face the fixing portion 192 and fix the filter assembly 170 to the front cabinet 181 with screws 184.

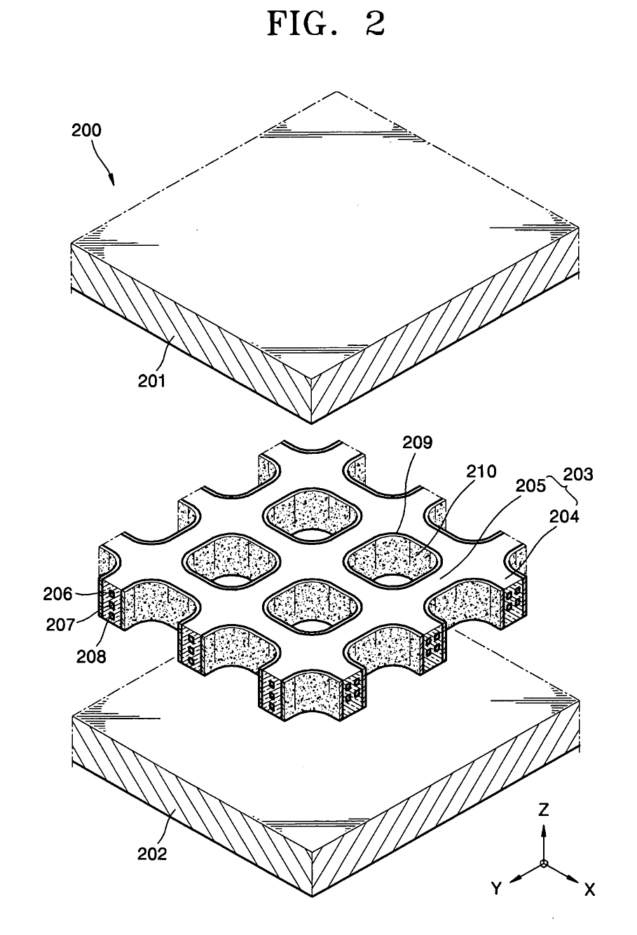

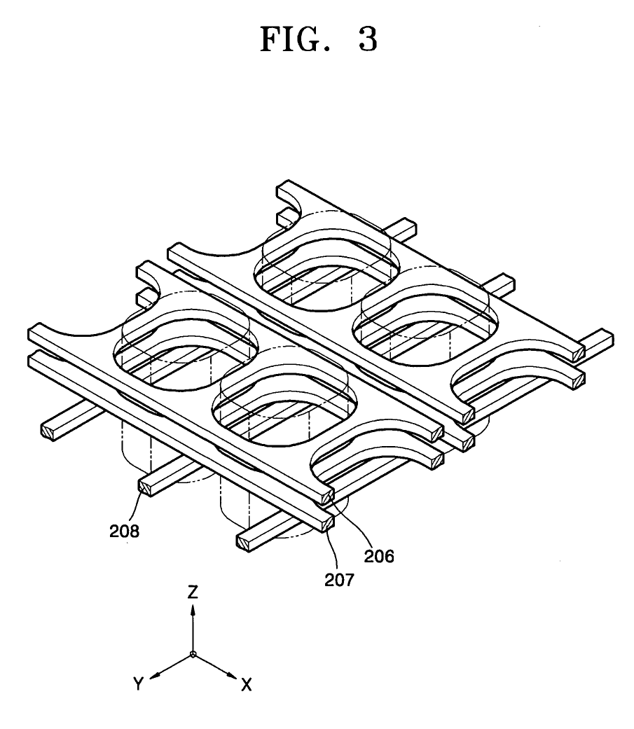

FIG. 2 is an exploded partial perspective view of a plasma display panel 200 according to an embodiment, which can be employed in the plasma display device assembly 100 of FIG. 1. FIG. 3 is perspective view of a discharge electrode of FIG. 2.

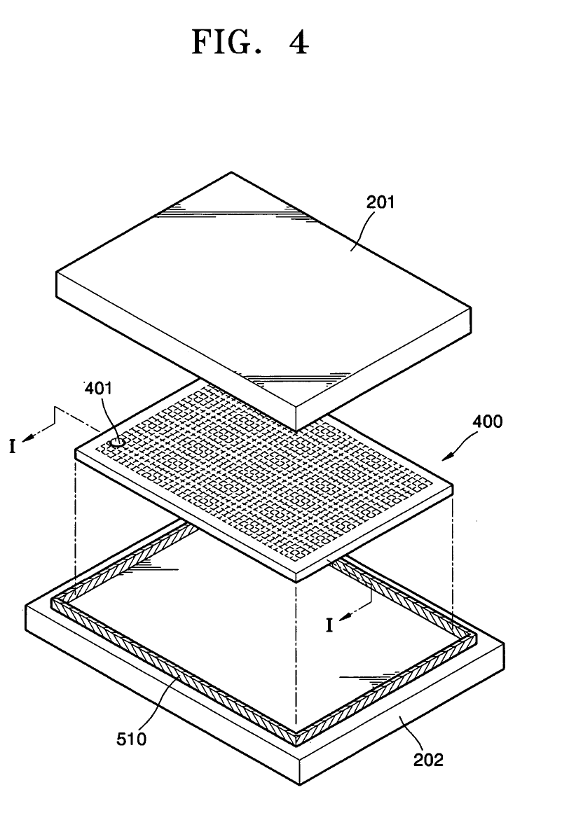

Referring to FIGS. 2 and 3, the plasma display panel 200 includes a front substrate 201, which is a first substrate, and a rear substrate 202, which is a second substrate, facing the front substrate. A sealing member 510 (see FIG. 4) such as frit glass is coated along edge surfaces of the front and rear substrates 201 and 202 to seal an inner space between the front and rear substrates 201 and 202 through thermal fusion.

Dielectric walls 203 that define a plurality of discharge cells together with the front and rear substrates 201 and 202 is disposed between the front and rear substrates 201 and 202. The dielectric walls 203 (see FIG. 2) are formed of a material having high dielectricity.

The dielectric walls 203 include a first dielectric wall 204 disposed in an X direction and a second dielectric wall 205 disposed in a Y direction. The second dielectric wall 205 extends in opposite directions from inner sides of a pair of the first dielectric walls 204 and forms one unit. The first and second dielectric walls 204 and 205 form a matrix.

Alternatively, the dielectric walls 203 can have various arrangements such as a meandering arrangement, a delta arrangement, a honeycomb arrangement, etc. Also, a horizontal cross-section of the discharge cells defined by the dielectric walls 203 can be rectangular, hexagonal, circular, or oval, but the present embodiments are not limited thereto.

A sustain discharge electrode pair composed of an X electrode 206, which is a first discharge electrode, and a Y electrode 207, which is a second discharge electrode is buried in the dielectric walls 203. The X and Y electrodes 206 and 207 are disposed along a circumference of the discharge cell.

The X electrode 206 is disposed relatively closer to the front substrate 201 than the Y electrode 207. The Y electrode 207 is separated from the X electrode 206 and is disposed relatively closer to the rear substrate 202 than the X electrode 206. The X electrode 206 and the Y electrode 207 are electrically insulated from each other, and can receive different voltages.

An address electrode 208, which is a third discharge electrode, crosses the X and Y electrodes 206 and 207 in the dielectric walls 203. The address electrode 208 is disposed between adjacent discharge cells that extend in the Y direction, and is buried in the dielectric walls 203.

A protective film layer 209 formed of a material such as MgO is deposited on the surface of the dielectric walls 203 (four side-walls of each discharge cell), and can emit secondary electrons due to interactions between ions generated in the front substrate 201 and the surface of the protective film layer 209.

Although it is not depicted in the drawings, a barrier rib structure can further be formed between the dielectric walls 203 and the rear substrate 202. The barrier rib structure is formed of a material having low dielectricity, unlike the dielectric walls 203. The barrier rib structure has substantially the same structure as the dielectric walls 203 in regions where the barrier rib structure corresponds to the dielectric walls 203. The barrier rib structure may consist of a first barrier rib disposed parallel to the first dielectric wall 204 and a second barrier rib disposed parallel to the second dielectric wall 205.

When only the dielectric walls 203 are disposed between the front substrate 201 and the rear substrate 202, the discharge cells are defined by walls consisting of one layer, and when the dielectric walls 203 and the barrier rib structure are disposed between the front substrate 201 and the rear substrate 202, the discharge cells are defined by walls consisting of two layers having different dielectric constants from each other.

The discharge electrodes in the plasma display panel 200 can be disposed in various ways according to the type of the plasma display panel 200. That is, surface discharge, facing discharge and hybrid type plasma display panels have different electrode structures. In the current embodiment, the electrodes have a structure that includes the X and Y electrodes 206 and 207, which are respectively a common electrode and a scan electrode, and generate a display sustain discharge, and the address electrodes 208 crossing the X and Y electrodes 206 and 207. The address electrodes 208 can be buried in the dielectric walls 203 where the X and Y electrodes 206 and 207 are buried or can be disposed on a surface of the rear substrate 202, but the address electrode 208 according to the present embodiments is not limited thereto.

A discharge gas such as a Ne gas, Xe gas, Ne—Xe gas or a He—Xe gas or a mixture thereof, is filled in the discharge cell defined by the front substrate 201, the rear substrate 202, and the dielectric walls 203.

Also, red, green, and blue phosphor layers 210 that emit visible light when excited by ultraviolet rays generated by the discharge gas are formed in each of the discharge cells. The phosphor layers 210 can be coated in any region of the discharge cell. However, in the current embodiment, the phosphor layers 210 are formed to a predetermined thickness on the dielectric walls 203 and on an upper surface of the rear substrate 202.

The red, green, and blue phosphor layers 210 are respectively coated in the discharge cells. The red phosphor layer may be formed of (Y,Gd)BO₃;Eu⁺³, the green phosphor layer may be formed of Zn₂SiO₄:Mn²⁺, and the blue phosphor layer may be formed of BaMgAl₁₀O₁₇:Eu²⁺.

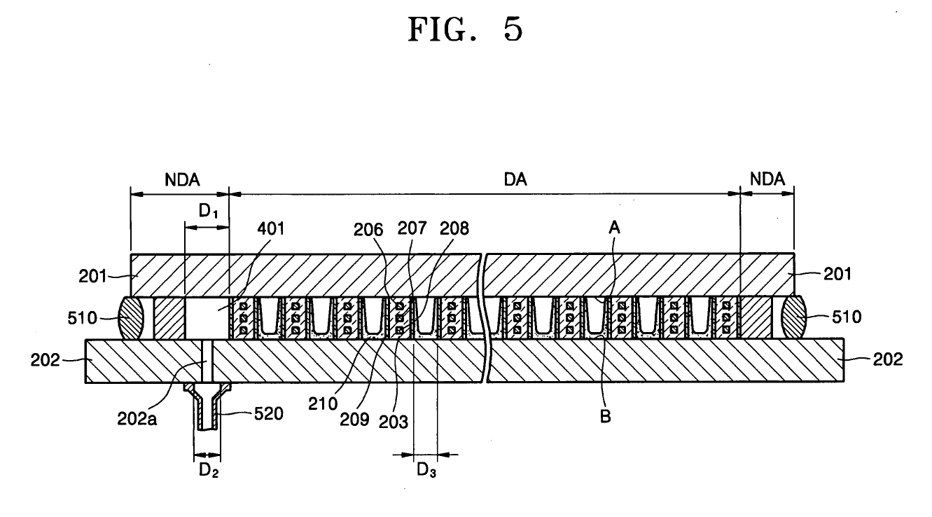

The dielectric walls 203 disposed between the front substrate 201 and the rear substrate 202 and the X electrode 206, the Y electrode 207, and the address electrode 208 buried in the dielectric walls 203 have a shape of a discharge sheet 400. The discharge sheet also includes an exhaust hole for discharging an exhaust gas. The details of the discharge hole are depicted in FIGS. 4 and 5.

FIG. 4 is an exploded perspective view of the entire plasma display panel 200 of FIG. 2, and FIG. 5 is a cross-sectional view taken along line I-I of FIG. 4.

Referring to FIGS. 4 and 5, the plasma display panel 200 includes the front substrate 201, the rear substrate 202 facing the front substrate 201, and the discharge sheet 400 disposed between the front substrate 201 and the rear substrate 202.

As described above, the discharge sheet 400 includes the dielectric walls 203 that define a plurality of discharge cells together with the front and rear substrates 201 and 202, the X electrode 206 disposed in the dielectric walls 203 along the side of the discharge cell, the Y electrode 207 separated a predetermined distance from the X electrode 206 and extending in the same direction as the X electrode 206, the address electrode 208 crossing the X and Y electrodes 206 and 207, the protective film layer 209 formed on an inner surface of the dielectric walls 203, the phosphor layers 210 coated on four the dielectric walls 203, and the discharge gas filled in the discharge cell.

The discharge sheet 400 has a thin film shape. That is, the discharge sheet 400 formed in a thin film shape including the dielectric walls 203 and the electrodes 206 through 208 buried in the dielectric walls 203 is interposed between the front and rear substrates 201 and 202.

An exhaust hole 401 for exhausting the exhaust gas during a vacuuming process is installed on an edge of the discharge sheet 400.

An inner space formed by coupling the front and rear substrates 201 and 202 is sealed by coating a sealing member 510 such as frit glass along edge surfaces of the front and rear substrates 201 and 202.

The coupled front and rear substrates 201 and 202 includes a display area DA where a plurality of discharge cells are disposed and an image is displayed using visible light emitted from the phosphor layers 210 when voltages are applied to the X and Y electrodes 206 and 207 and the address electrode 208, and a non-display area NDA where the X and Y electrodes 206 and 207 and the address electrode 208 are electrically connected to external terminals.

The discharge sheet 400 is disposed over the display area DA and the non-display area NDA. The exhaust hole 401, having a predetermined diameter, is formed in the non-display area NDA of the discharge sheet 400. The diameter D₁ of the exhaust hole 401 is greater than the diameter D₃ of the discharge cell defined by the dielectric walls 203.

An exhaust pipe 520 is installed on an outer side of the rear substrate 202. The exhaust pipe 520 is connected to the exhaust hole 401 through a connection hole 202a formed through the rear substrate 202. The diameter D₁ of the exhaust hole 401 is greater than the diameter D₂ of the exhaust pipe 520.

A method of manufacturing the plasma display panel 200 will now be described.

A front substrate 201 and a rear substrate 202 are prepared.

A discharge sheet 400 is disposed between the front substrate 201 and the rear substrate 202. The discharge sheet 400 includes dielectric walls 203 that define a plurality of discharge cells together with the front and rear substrates 201 and 202, and a plurality of discharge electrodes 206 through 208 buried in the dielectric walls 203. The discharge sheet 400 can further include a protective film layer 209 formed on the dielectric walls 203, and phosphor layers 210. Alternatively, the protective film layer 209 and the phosphor layers 210 can be formed when the dielectric walls 203 are disposed on one of the front and rear substrates 201 and 202.

The discharge sheet 400 has an exhaust hole 401 in a non-display area NDA of the coupled front and rear substrates 201 and 202. The diameter D₁ of the exhaust hole 401 is greater than the diameter D₃ of the discharge cell defined by the dielectric walls 203, and greater than the diameter D₂ of an exhaust pipe 520 which will be installed in a vacuuming process.

Next, a sealing member such as frit glass is coated along inner surfaces of the front and rear substrates 201 and 202, and then, the discharge sheet 400 is disposed between the front and rear substrates 201 and 202. After the front and rear substrates 201 and 202 are coupled, a space therebetween is sealed.

Next, the exhaust pipe 520 is installed on an outer surface of the rear substrate 202 to be connected to the exhaust hole 401, and the space between the front and rear substrates 201 and 202 can be vacuumed.

When vacuuming the space, a space on regions A of the front substrate 201 has a degree of vacuum different than a space on regions B of the rear substrate 202 where the exhaust pipe 520 is installed vacuum. To reduce the difference between the degrees of vacuum of the regions A and the regions B, the temperature of an exhaust gas can be increased. However, in this case, the time required for vacuum saturation increases, thus increasing the overall vacuuming time.

In a current embodiment, the discharge sheet 400 includes the exhaust hole 401 having a diameter D₁ greater than the diameter D₃ of the discharge cell in the non-display area NDA of the plasma display panel 200, and the exhaust hole 401 is connected to the exhaust pipe 520 via the connection hole 202a formed through the rear substrate 202.

In the prior art, vacuuming of the space between the front and rear substrates is sequentially achieved from an exhaust pipe, inner regions of the rear substrate where the exhaust pipe is installed, and inner regions of the front substrate opposite the rear substrate. However, in the current embodiment, the inner regions A of the front substrate 201 and the inner regions B of the rear substrate 202 of the plasma display panel 200 are vacuumed at the same time through the exhaust pipe 520, due to the presence of the exhaust hole 401. Accordingly, the inner regions A of the front substrate 201 and the inner regions B of the rear substrate 202 of the plasma display panel 200 are maintained at substantially identical vacuum states.

After the space between the front and rear substrates is vacuumed, the discharge gas is filled in the discharge cell and is aged. Through the vacuuming process, an exhaust gas containing air or impurity gases remaining in corners of the front substrate 201 and the rear substrate 202 can be exhausted through the exhaust pipe 520 utilizing the exhaust hole 401. After the vacuuming process is completed, an end portion of the exhaust pipe 520 is sealed using a tip-off process.

The plasma display panel manufactured according to the method of manufacturing a plasma display panel of the present embodiments has the following advantages.

First, an exhaust hole formed between the front and rear substrates has a greater diameter than the discharge cell defined by the dielectric walls. Therefore, when a space between the front and rear substrates is vacuumed, inner regions of the front substrate and inner regions of the rear substrate are maintained at substantially identical vacuum status.

The exhaust hole is formed in the discharge sheet, and the discharge cells can be smoothly vacuumed through the exhaust hole.

The discharge sheet is disposed between the front and rear substrates in a thin film sheet, thereby simplifying the manufacturing process.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a front substrate;
a rear substrate facing the front substrate; and
a discharge sheet which is disposed between the front and rear substrates comprising one or more exhaust holes that provide a gas exhaust path for discharging a gas from a sealed discharge space during a vacuuming process.

2. The plasma display panel of claim 1, wherein the discharge sheet comprises:
a plurality of dielectric walls that define a plurality of discharge cells together with the front and rear substrates;
a plurality of discharge electrodes that are disposed in the dielectric wall and surround the discharge cells;
a plurality of phosphor layers formed in the discharge cells; and
a discharge gas in the discharge cells.

3. The plasma display panel of claim 2, wherein the discharge electrodes comprise:
a plurality of first discharge electrodes extending in a first direction;
a plurality of second discharge electrodes extending in the first direction, wherein a sustain discharge voltage is alternately applied to the first and second discharge electrodes; and
a plurality of third discharge electrodes that intersect the first and second discharge electrodes, wherein an address voltage is alternately applied to the second and the third discharge electrodes.

4. The plasma display panel of claim 3, wherein the first discharge electrodes are disposed relatively closer to the front substrate than the second discharge electrodes and the second discharge electrodes are disposed relatively closer to the rear substrate than the first discharge electrodes.

5. The plasma display panel of claim 2, further comprising a barrier rib structure defining the discharge cells together with the dielectric walls between the discharge sheet and the rear substrate.

6. The plasma display panel of claim 2, wherein the dielectric walls are covered by a protective film layer.

7. The plasma display panel of claim 2, wherein the discharge sheet is a thin film sheet.

8. The plasma display panel of claim 2, wherein the exhaust hole is connected to an exhaust pipe installed on an outer surface of at least one of the front and rear substrates via a connection hole perforated through at least one of the front and rear substrates.

9. The plasma display panel of claim 8, wherein a discharge space formed by coupling the front and rear substrates defines a display area where an image is displayed and a non-display area along the edges of the display area, and the exhaust hole is formed in the non-display area.

10. The plasma display panel of claim 8, wherein the exhaust hole has a greater diameter than each of the discharge cells defined by the dielectric wall.

11. The plasma display panel of claim 8, wherein the exhaust hole has a greater diameter than the exhaust pipe.

12. A method of manufacturing a plasma display panel, comprising:
preparing a front substrate and a rear substrate and arranging the front and rear substrates to face each other;
forming an exhaust hole in a discharge sheet;
disposing the discharge sheet between the front and rear substrates;
sealing a space between the front and rear substrates by coating a sealing member along edge surfaces of the front and rear substrates; and
vacuuming the space between the front and rear substrates through an exhaust pipe formed on an outer surface of one of the front and rear substrates and connected to the exhaust pipe.

13. The method of claim 12, wherein the discharge sheet comprises dielectric walls that define the discharge cells together with the front and rear substrates, a plurality of discharge electrodes buried in the dielectric walls, and wherein the discharge sheet has exhaust holes.

14. The method of claim 13, wherein, the forming of the exhaust hole comprises forming the exhaust hole in a non-display area which is formed along edges of a display area of a panel and is an area where the discharge electrodes are electrically connected to external terminals.

15. The method of claim 14, wherein the exhaust hole has a greater diameter than the discharge cells defined by the dielectric walls.

16. The method of claim 14, wherein the exhaust hole has a greater diameter than the exhaust pipe.
